(19) United States
(12) Patent Application Publication
(10) Pub. No.: US 2004/0022069 A1
(43) Pub. Date: Feb. 5, 2004

(54) Night time numbers

(76) Inventor: Chris Zugelder, Olathe, KS (US)

Correspondence Address: Chris Zugelder, 15035 W. 139 Street, Olathe, KS, 66062, US

(21) Appl. No.: 10/207,754

(22) Filed: Jul. 30, 2002

(51) Int. Cl. F21V 7/04

(52) U.S. Cl. 362/555

(57) ABSTRACT

Night Time Numbers consist of a solar, illuminated house identification fixture with a plastic body that contains an inner space for receiving solar powered batteries, a digital LED device with it's control circuit, a sensor unit for automatically turning the LED's off during bright time and on during dark time. The body and components provide a digital light numeral for the house number.

An illuminated number, readable during the night or day, and suitable for use as a house number display, uses a single, independent, illuminatable body. The illuminatable body is made of an array of LED's, with a diffuser to produce a uniform illumination, and is powered by one or more batteries. A light detector senses the onset of dusk, which activates the illuminatable body, turning it on, and leaving it on for four or more hours. A constant-current electronic system powers the LED's, which are pulsed on and off at a speed greater than 90 Hz, which makes the sign appear to the human eye as constantly illuminated. The rechargeable batteries shall illuminate the body for dark hours and recharge during light hours.

### BACKGROUND OF THE INVENTION

1. Field of the Invention

The current invention is a device for visually indicating house numbers during both light hours and dark hours. More specifically, this invention relates to such a device, which provides an easy modification for different numbers, and is battery operated but causing a low power drain. This device uses a power source of solar energy.

2. Description Relative to the Prior Art

Illuminated house numbering devices are well known, and there is a lot of prior articles describing such systems. Typical of these is U.S. Pat. No. 5,007,190, which provides a programmable system that is solar powered, thus allowing the device to be installed without connection to the internal wiring system of the house. The solar cells of this prior device are used to charge an internal battery during the day, and the battery powers the device at night.

Devices such as the one described above suffer from a common shortcoming however: complexity, resulting in high purchase price, and high maintenance and replacement cost.

Furthermore, many of these devices do not provide a numbering visible during the day, since the typical illuminated characters chosen do not provide a display, which is easily discernable during daylight hours.

In U.S. Pat. No. 5,522,540, issued Jun. 4, 1996, to Robert L., Surman, titled “Solar Powered Illuminated Address Number Device and Mailbox Structure”, the illumination feature is made part of a mailbox in the teaching and in the independent claims. Also the internal battery is powered by solar energy. This invention has the disadvantage of using solar energy to power the battery and the disadvantage of increased cost. Also it is associated with a mailbox and not necessarily useful in other location such as inside buildings.

The device described herein solves these problems by providing a simple, low-cost and low power consuming system that is visible both during the day and at night. The electronics are simple, and the power drain is quite low. The recharging of the battery(s), when necessary, is done off line, further reducing the cost and complexity of the device.

This solution employs the use of Light Emitting Diodes, (LEDs) which are very efficient in converting electrical energy into light. Also, we use a low duty cycle for the current flow through the LEDs to conserve average energy. Further improved energy utilization is achieved by operating the LEDs in series.

Our invention permits display of the numbers and or messages and with high contrast in daylight.

The advantages of the present device include the simplicity of the power supply which uses standard, rechargeable flashlight batteries, the use of low cost electronics to extend battery life, the ability to easily change address numbers and flexibility allowing the display of changeable alphabetic messages such as but not limited to street names, or occupant names.

### SUMMARY OF THE INVENTION

It is an object of the current invention to provide a simple, low-cost illuminated house sign in which the numbers contained therein are visible both day and night. It is a specific object of the invention to provide such a sign with a modular design, and providing long battery life.

In accordance with one aspect of the present invention, an illuminated sign includes a power source, an illuminatable body powered by the power source and necessary parts and circuitry.

In accordance with a second aspect of the invention, the invention includes switching means to switch power from the power source to the illuminatable body on and off.

In accordance with a third aspect of the invention, each body can be made of various opaque colors of plastics. As a result, the identity of the character is visible even when the illuminatable panel is not illuminated.

In accordance with a fourth aspect of the invention, the power source is a battery.

In accordance with a fifth aspect of the invention, the sign includes a dusk detector and a timer which is activated when the dusk detector detects the onset of dusk and remains activated for an illumination period. As a result, power is switched off from the illuminatable panel except during the illumination period.

In accordance with a sixth aspect of the invention, the sign has a body, and the circuitry is retained in the body by slides formed in the body.

In accordance with a seventh aspect of the invention, the illuminatable panel is a florescent and opaque illuminatable panel.

In accordance with an eighth aspect of the invention, the illuminatable panel is made up of a substantially equally spaced array of LED's and a diffuser disposed in front of the illuminatable panel.

In accordance with a ninth aspect of the invention, constant current electronic means to are used to illuminate the LEDs.

### BRIEF DESCRIPTION OF THE DRAWINGS

These, and further features of the invention, may be better understood with reference to the accompanying specification and drawings depicting the preferred embodiment, in which:

FIG. 1 depicts the front view of a body of a single character, in this case the number “0”. The photovoltaic cell and sensor is positioned on top of the character to collect sunlight. The rechargeable battery(s) is placed internally inside the body and connected to the sensor, LED's and other circuitry.

FIG. 2 depicts the side view of the same character “0”. Some electrical parts have been shown. Wiring has been omitted for clarity.

FIG. 3 depicts a rough sketch of the circuitry design to be implemented in each character. This is a simple, generic circuit, commonly used in other applications and designs. Other characters (1, 2, 3 . . . ) will use this same or similar circuitry design

### DESCRIPTION OF THE PREFERRED EMBODIMENTS

The invention provides an illuminated sign appropriate for displaying street numbers for residences, and similar uses.

The invention, in its preferred embodiment, is simple and relatively inexpensive, using a single illuminatable panel.

Referring first to FIG. 1, a body for the number “0” is shown. The body contains an opaque, plastic body.

Arranging the appropriate character bodies in order creates a multi-digit number.

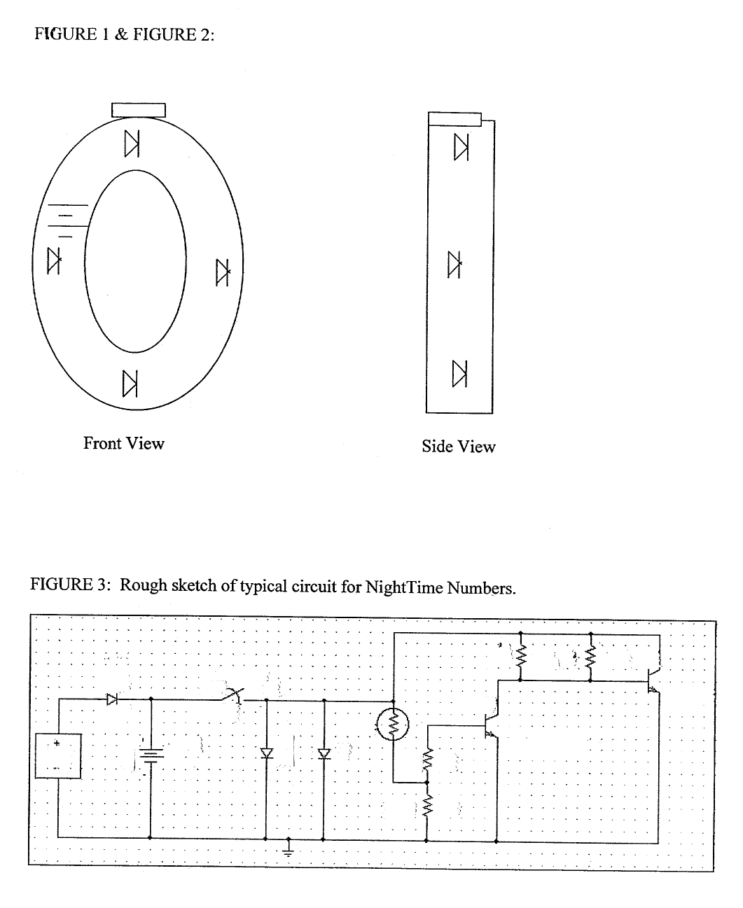

The device is shown in FIG. 2. Referring now to this figure, it is seen that the body housing contains a photosensitive element atop the housing, so that it is exposed to the light, and may detect the onset of dusk.

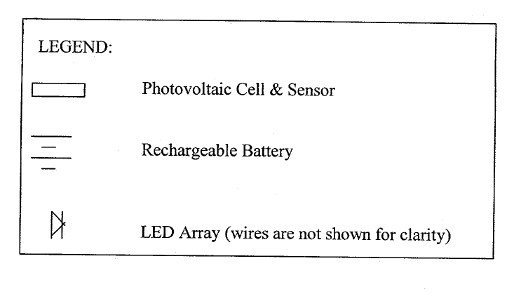

Within the housing are a circuit board, and battery(s) as shown in FIG. 3. Finally, when all the aforementioned components are mounted within the housing, the body is sealed to protect the components against the weather.

One of the problems not addressed by other lighted house signs is that they do not show up well during daylight hours, even when illuminated. In the present invention, this problem is solved by purely mechanical, non-electronic means. The opaque colors chosen for the body shall be dark enough for daylight visibility, but allow the light emitting diodes to be seen at night.

### FIRST ALTERNATIVE EMBODIMENT—LED ARRAY ILLUMINATABLE PANEL

In this embodiment, the illuminatable panel is made up of an LED array, with the LEDs more or less uniformly spaced about the illuminatable panel, and with one or more diffusers to reduce brighter areas and make illumination more uniform. In its simplest form, the diffuser is a molded plastic arrangement of bumps, similar to a bicycle reflector. Other forms of diffusers include glass or plastic with an irregular surface, such as the diffusers used in the taillights of automobiles, which scatter the light internally, and give a more or less uniformly lighted surface. Diffusers may also be reflective in nature, with the reflective surfaces having irregularities that reflect incident light in many different directions, so that the net effective will be to create a more-or-less constant light intensity throughout.

When the illuminatable panel is switched off during daylight hours, and the sign is visible in daylight, the numbers are visible because the light entering the body is reflected by the diffuser behind the bodies front panel.

The interior of the sign enclosure is made of materials, which produce reflecting interior surfaces to redirect light back into the diffuser. Thus, when the illuminatable panel is illuminated, the reflections affect a reuse of some of the reflected light through the viewing region.

### HIGHER EFFICIENCY EXTENDS OPERATING LIFE OF BATTERIES

This alternative embodiment uses a number of power-saving techniques and devices to prolong battery-operating time. These include the use of low power CMOS semiconductors in the logic circuitry of the electronics.

Rather than leaving the sign illuminated all day, continuous detection of light level uses photo detector and low power CMOS trigger circuit to turn on power only when daylight fades at dusk, and will leave the illuminatable panel illuminated only for a fixed, although user configurable, period of time, typically four to six hours, after dusk. Other alternative embodiments provide for a wider range of “on” times, or for a continuously variable setting.

Power is conserved by operating the LEDs in series from a single current source with low loss. Depending upon the configuration of the LEDs, they may be grouped in clusters, each cluster having its own constant current source.

Prior article LED power supplies use constant voltage in series with a resistor, to produce the desired current. The operating voltage of an LED is about 1.8 volts and is nearly constant over a wide range of currents and light intensity. The supply voltage is dependent on the number of batteries used and changes as the batteries are discharged. Thus normally much of the energy is wasted in the series resistor that is used to maintain constant current through the LED. In contrast, the present embodiment, the LEDs are supplied by a means of constant current circuit, which does not use the dropping resistor in series with the LED.

There are a variety of semiconductor circuits which can provide the constant current required by the LEDs without the power loss of the dropping resistor approach, but this increases the cost of the device,

In this present invention the current is provided to the array of LEDs connected in series and the current is provided by the energy stored in an inductor in series with the LED array. The inductor is operated in the blocking oscillator mode where the circuit is pulsed by means of a semiconductor switch connected in series with the inductor and the power supply. The switch is connected across the series array of LEDs and when the switch is on it permits current to flow into the inductor thus storing energy into the inductor magnetic field. When the switch is opened, the magnetic field collapses thus generating a large flyback voltage from the inductor. This produces a current through the series connected array of LEDs without any power loss in a series resistor. In each pulse, the initial output current from the inductor is essentially the same as the final current used in charging the inductor. The use of this blocking oscillator means for powering a series array of LEDs is largely responsible for the high efficiency and extended operation from the batteries.

Another important contribution to the longer operating life from the batteries is the use of a voltage regulator for the output from the batteries. As the batteries reach near end of their capacity and life the output voltage decreases and the output light would normally decrease near the end. By using an efficient voltage regulator, the power supply voltage is maintained more constant thus using more of the remaining battery life to give stable and useful display life.

### INCLUDED CONTROLS

The present embodiment uses an internal dusk (light) sensor to turn device on as dusk approaches.

The device can have more than one lighted illuminatable body, each of which can contain different messages. An example can be one panel showing address numbers, and another can display the street name, and another can display the name of the occupants and/or business. Individual display panels or combinations can be independently powered and selected by switches.

### DETAILED DESCRIPTION OF THE EMBODIMENT

Referring now to FIG. 1, a block diagram of the device is depicted. Batteries provide continuous standby current at very low levels to a light sensor 20 that is monitored by a low power CMOS threshold circuit, which is part of the electronics. The battery(s) also continuously power the threshold portion of the electronics. The standby current is in the microampere range and only reduces the battery energy and life by a very small amount. When the threshold circuit detects that the light on the light sensor falls below a preset value, the threshold circuit activates power to the rest of the electronics, which energizes the LED array. The light from the array passes through a diffuser, which makes the light source appear more uniform.

The LED array is made up of a number of individual LEDs spaced more or less evenly around the array illuminatable panel. The photo sensor is mounted in the plane of the LED array, and contains a filter to reject light of the wavelength of the LEDs of the array. In alternative embodiments the photo sensor is mounted on the surface of the enclosure.

It should be noted that the techniques described in this embodiment could be used with arrays of LEDs configured to produce symbols, which depend on the body. The same power-conserving electronics could be used.

While the invention has been described with reference to specific, preferred embodiments, it will be apparent that the invention is not to be limited to the disclosed embodiments. This document is intended to cover various modifications and equivalent arrangements included with the spirit and scope of the appended claim, which scope is to be accorded the broadest modifications and equivalent structure. Improvements and modifications may be made within the preview of the invention without departing from the scope of the invention defined in the appended claims.

I claim:

1. An illuminated sign, comprising:
(a) one or more rechargeable batteries;
(b) an illuminatable panel powered by the batteries, and further comprising a multiplicity of LEDs; switching means which switch the LEDs on and off at a pulse rate beyond the critical flicker fusion frequency; which vary the pulse rate, which cause the LED's to remain on for an on period after being switched on, and which vary the duration of said on period;
(c) light diffusing means disposed in front of the illuminatable panel.

2. The sign of claim 1, further comprising a constant, electronic current to illuminate the LEDs.

3. The sign of claim 2, wherein the sign further comprises:
(a) a dusk detector,
(b) timing means which is activated when the dusk detector detects the onset of dusk and remains activated-for an illumination period; and
(c) means to control the illumination period,
so that said timing means switches power from the batteries to the illuminatable panel off except during the illumination period.

4. The sign of claim 3, further comprising switching means to flash the sign on and off at a rate not perceivable to the human eye.

5. The sign of claim 4, wherein the light diffusing means further comprises a panel having an opaque color, so that the bodies are easily visible during daylight hours, when the illuminatable panel is not illuminated.

6. The sign of claim 5, wherein the bodies have a front side and a backside, the front side being opaque in color, and the backside having a reflective surface. Light from the reflective surface reflects off the light diffusing means, further illuminating the light diffusing means.
